(19) United States
(12) Patent Application Publication
(10) Pub. No.: US 2014/0279225 A1
(43) Pub. Date: Sep. 18, 2014

(54) PROVIDING INSTRUCTIONS FOR CONDUCTING AN INSPECTION OF AN ASSET

(71) Applicant: Auction.com, LLC, Irvine, CA (US)

(72) Inventor: Robert Friedman, Laguna Hills, CA (US)

(73) Assignee: Auction.com, LLC, Irvine, CA (US)

(21) Appl. No.: 14/210,203

(22) Filed: Mar. 13, 2014

Related U.S. Application Data
(60) Provisional application No. 61/800,567, filed on Mar. 15, 2013.

(51) Int. Cl. G06Q 30/06

(52) U.S. Cl. CPC G06Q 30/0609
USPC 705/26.35

(57) ABSTRACT

A method for conducting an inspection of an asset on a computing device is provided. One or more processors prompt a user to enter inputs, including an input that is indicative of a type of asset that is being inspected. Based, at least in part, on the type of asset, instructions are provided that are specific to the type of asset for the user to follow in performing the inspection. User input corresponding to each of the instructions are received, and a report is generated based on the received user inputs.

### RELATED APPLICATIONS

This application claims benefit of priority to Provisional U.S. Patent Application No. 61/800,567, filed Mar. 15, 2013, entitled PROVIDING INSTRUCTIONS FOR CONDUCTING AN INSPECTION OF AN ASSET; the aforementioned application is hereby incorporated by reference in its entirety.

### TECHNICAL FIELD

Examples described herein pertain generally to a system and method for providing instructions for conducting an inspection of an asset through use of computing devices.

### BACKGROUND

Transactions for the purchase or sale of some types of assets can require reports that identify the overall quality of an asset and/or specific problems with the asset.

### BRIEF DESCRIPTION OF THE DRAWINGS

FIG. 1 illustrates an example system for providing instructions for conducting an inspection of an asset based on the type of asset being inspected.

FIG. 2 illustrates an example method for providing instructions for conducting an inspection of an asset and generating a report for the inspection.

FIGS. 3A through 3E illustrate example user interfaces providing instructions for conducting an inspection of an asset.

FIG. 4 is a block diagram that illustrates a computing device upon which examples described herein may be implemented.

### DETAILED DESCRIPTION

Examples described herein provide a system and computer-implemented method for providing a tool for assisting a user with inspecting an asset using a computing device. A user can operate the computing device that provides instructions specific to the type of asset that is being inspected and that generates a report to be transmitted to other services once the inspection has been completed by the user.

According to an example, the user can be prompted to enter a variety of inputs, including an input that is indicative of a type of asset that is being inspected. Based, at least in part, on the type of asset selected, instructions are provided (specific to the type of asset selected) for the user to follow in performing the inspection. The instructions can be presented, for example, on a display of a computing device operated by the user. The user can provide user input corresponding to each of the instructions, and a report can be generated based on the user inputs. In some examples, the report can be transmitted to a service and/or linked to an online listing for transaction for the asset.

The user can also specify information about one or more characteristics of the asset. In this manner, the instructions that are provided can be selected or configured based on the one or more characteristics in order to be tailored for the specific asset being inspected. In some examples, the asset can correspond to a real property asset, and the one or more characteristics can identify a type of the real property asset, a geographic location of the real property asset, or a transaction type for the real property asset. The transaction type can correspond to a consumer-to-consumer transaction, a short sale, a foreclosure, or other types of transactions.

In some examples, the system can provide instructions that specifically guide the user to capture images in order to verify aspects of the inspection and the condition of the asset. The instructions that are provided to the user can include audio instructions and/or displayed user interfaces that provide instructions in the form of text, images, and/or videos. The user can provide user inputs corresponding to the instructions (i) by speaking into a microphone, (ii) by interacting with a touch-sensitive display and/or one or more other input mechanisms, and/or (iii) by capturing an image using a camera of the computing device. The report for the inspection of the asset can be generated by determining a report template corresponding to the type of asset, and including content based on the received user inputs.

As used herein, an “asset” can refer to a tangible item or a product. Examples of an asset can include any item for sale, a vehicle, an antique item, real estate property, etc. Also as used herein, a “user” can refer to an individual operating a computing device. An example of a user can include an owner of an asset, a product evaluator, a home inspector, an appraiser, etc.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

FIG. 1 illustrates an example system for providing instructions for conducting an inspection of an asset based on the type of asset being inspected. According to some examples, system 100 can be implemented through software that operates on a computing device, such as a mobile computing device. The components of system 100 can combine to assist a user in conducting an inspection of an asset by providing instructions that are tailored to the type of asset being inspected. Based on the user input received corresponding to the instructions, system 100 can generate a report for the inspection.

In one example, system 100 includes an instruction generate 110, a response associate 120, a report generate 140, and a service interface 160. System 100 can also include one or more databases, such as an instructions database 130 and a templates database 150 that are stored in a memory resource of a computing device that operates system 100. The components of system 100 can combine to provide a tool or guide in assisting a user to conduct an inspection of an asset. The tool or guide can provide instructions that are tailored specifically to the type of asset and/or characteristics of the asset. In some examples, system 100 can be operated on a computing device as part of a program or application.

Some or all of the components of system 100 can be implemented on one or more computing devices, such as on one or more servers or one or more mobile computing devices. System 100 can also be implemented through other computer systems in alternative architectures (e.g., peer-to-peer networks, etc.). System 100 can also be configured to communicate with one or more services 170 that can, for example, provide a forum or online listing for transactions for assets.

According to examples, a user can operate a computing device, such a mobile computing device, to conduct an inspection of an asset. The instruction generate 110 can provide specific instructions that correspond to a type of asset being inspected by the user. The instruction generate 110 can receive information about the type of asset 113 as well as other information about the asset, such as one or more characteristics of the asset. In one example, the instruction generate 110 can provide a prompt to a user that is displayed as part of a user interface. The prompt can request the user to provide one or more selections or inputs that specify the asset the user is inspecting. The user can provide a variety of inputs, including an input that indicates the type of asset 113 that is being inspected (e.g., new product, collectible, antique, vehicle, real estate property, etc.), and other inputs that indicate one or more characteristics of the asset (e.g., style, location, age, etc.).

For example, the user can provide an input that is indicative of a type of asset 113, such as a real estate property. Once the type is selected, the prompt can request the user to provide additional input about the selected type. The user can then provide input that indicates one or more characteristics of the real estate property, such as the type of real estate property (e.g., a house, a condo, an apartment, a business property, land, etc.), the location the property is located in, the age of the real estate property (e.g., when it was built), the type of transaction the real estate property is being inspected for (e.g., a consumer-to-consumer transaction, a short sale, a foreclosure) or other characteristics about the real estate property.

Based on the asset type 113 and/or one or more characteristics of the asset, the instruction generate 110 can provide instructions 111 that guide the user in conducting an inspection of the asset. These instructions 111 can be specific to or be particularly tailored for the asset type 113. For example, an instructions database 130 can store a plurality of instructional content that are associated with different types of assets, as well as different characteristics of the assets. The instruction generate 110 can access or communicate with the instructions database 130 to determine, select, and/or configure the instructions 111. For example, the instruction generate 110 can reference or search the instructions database 130 using the specified asset type 113 to determine the instructions content 131 for that asset type. The instruction generate 110 can then provide the instructions 111 to the user using one or more output mechanisms of the computing device.

The instructions 111 can provide the user with guidance on the various aspects of the inspection process for the particular type of asset being inspected. For example, referring back to the asset type as being a real estate property, the instructions 111 can guide the user to inspect the roof, the basement, the air conditioning or heating system, the plumbing, the electrical system, the water heater, the fire alarm system, the yard sprinkler system, etc. For other types of assets, different inspection instructions can be provided. For example, for a vehicle being inspected, the instructions 111 can guide the user to inspect the paint job, the electrical system, the engine, the tires, the brakes, the interior, etc.

The instructions 111 can be provided to the user as audio instructions via one or more speakers of the computing device and/or as displayed user interfaces via a display of the computing device. The displayed user interfaces can provide instructions in the form of text, images, and/or videos. In some examples, the user can configure the manner in which the instructions 111 are to be provided by the instruction generate 110. In response to the provided instructions, the user can provide user inputs 121 corresponding to each of the instructions via one or more input mechanisms of the computing device (e.g., a microphone, touch-sensitive display, keyboard, buttons, camera, etc.).

The response associate 120 can operate in connection with the instruction generate 110 to associate the received user inputs 121 with the appropriate instructions 111. For example, the instructions 111 can include a question or request pertaining to a particular aspect of the inspection and provide multiple answer choices for the request. As an example, an instruction 111 can specify directions the user should take when inspecting a roof of a house (the asset), and prompt the user for responses to specific inquiries, such as “do you see any holes on the roof?” or “what condition are the gutters in?” The user can select one or more preconfigured answers or choices. As an addition or alternative, the instructions 111 can also provide text fields to receive one or more characters as a response to a query in an instruction 111 (e.g., via interaction with a touch-sensitive screen, buttons, or a keyboard, or via audio input through use of a microphone).

The instructions 111 can also include prompts asking the user to take an image or video of particular aspects of the inspection. The images and/or videos can provide verification of the condition of the asset. As discussed, system 100 can operate on a mobile computing device that includes one or more camera components for capturing images. Referring back to the example of inspecting a house, the instructions 111 can direct the user to capture an image for each of, for example, a scene that depicts a portion of the roof (e.g. “take a picture showing a defect of the roof.”), the water heater, the plumbing, etc., that is of significance to the asset inspection. For example, the instructions 111 can prompt the user to take images of defects in a kitchen countertop (stains, cracks, chips, etc.) if the user sees any such problems with it during the course of the inspection. In some examples, the user is instructed to take an image of the defect only when the user inputs a preconfigured answer to the prompt (e.g., “yes”). The captured images (or videos) can be provided to the response associate 120 as user inputs 121 that correspond to particular instructions 111. Once the user responds to an instruction 111 by providing user inputs 121 via any one or more of the input mechanisms, the response associate 120 can associate the user input 121 with the corresponding instruction 111 as a response 123.

Each of a plurality of responses 123 can correspond to a user input(s) for a corresponding instruction 111. In some cases, a response 123 can be left blank (or identified as being ignored or not applicable) if the user did not provide a response to an instruction 111. The response associate 120 can provide the plurality of responses 123 to the report generate 140.

The report generate 140 can determine the asset type 113 and/or one or more characteristics of the asset in order to select a report template 151 for generating a report. For example, the report generate 140 can determine the asset type 113 and/or the characteristic(s) of the asset in response to the variety of inputs provided by the user (e.g., such as described with the instruction generate 110). In another example, the report generate 140 can determine the asset type 113 and/or the characteristic(s) of the asset based on the responses 123 received from the response associate 120. Still further, the report generate 140 can receive the determined asset type 113 and/or the characteristic(s) of the asset from the instruction generate 110 and/or the response associate 120.

The report generate 140 can select a report template 151 that is suitable for the asset type 113 and/or one or more characteristics of the asset. For example, a templates database 150 can store a plurality of report templates 151 that correspond to different types of assets having different characteristics. The report generate 140 can access the templates database 150 to select the appropriate report template 151 for the asset type 113 and/or one or more characteristics of the asset. For some types of assets, rules and regulations can control or standardize (i) how an inspection for that type of asset is to be performed, and/or (ii) what kind of information is necessary to comply with the rules and regulations. By selecting the appropriate report template 151, the report generate 140 can generate a report 141 that can include necessary information in the appropriate format for the asset type 113.

The report generate 140 can fill in or complete the selected report template 151 using the plurality of responses 123. Once the necessary information is included, the report generate 140 can generate and/or store a report 141 corresponding to the conducted inspection of the asset. Depending on implementations, the report 141 can include a plurality of information in addition to the plurality of responses 123. For example, the report 141 can include information of the user, the date the inspection took place, location information, a description of the different items/aspects of the asset that were inspected, whether or not the different items/aspects were approved or rejected (or passed/failed), etc. In some examples, the report 141 can also include one or more images, audio data, video data, etc., that have been captured or recorded as part of a response to an instruction 111. In this manner, the report 141 identifies the condition of the asset and provides a summary of the findings from the inspection of the asset. Such a report 141 can be helpful to parties, for example, that are transacting with one another for the purchase or sale of the asset.

In some examples, the service interface 160 can provide the report 161 to one or more services 170 (e.g., to one or more computing devices or servers remote from system 100). In particular, the service interface 160 can use one or more network resources of the computing device to provide communications over a wireless network. The network resources can include, for example, a cellular data/voice interface to enable the device to receive and send network communications over a cellular transport. As an alternative or variation, the network resources can include a wireless network interface for connecting to access points (e.g., Wireless Fidelity 802.11(g) or 802.11(n)) or for using other types of wireless mediums (e.g., Wi-Max). The service interface 160 can also format the report from a first format to a second format based on the particular service 170 that is to receive the report 161 (e.g., formatted as a PDF file, HTML file, or XML file, etc.).

The services 170 can include, for example, email services (so that the report 161 can be provided to the user's and/or different parties' email addresses or accounts), banking services, real estate management services, governmental agencies, and/or online transactional services. For example, the report 161 can be provided to the online transactional service (e.g., that provides a transaction medium in a networked environment) so that the report 161 can be linked to an online listing for transaction for the asset. Users or individuals having an interest in the asset (e.g., a real estate agent, a buyer, a seller, a banker, etc.) can access the online listing for the transaction for the asset in order to view the report 161. In addition, because the report 161 can include a plurality of images or videos that provide verification of an asset and the condition of the asset, system 100 can enable remote or virtual inspection of the asset.

As an addition or an alternative, system 100 can also provide a rating or feedback for the user that performs the inspection. For example, when the report 141 is generated, system 100 can evaluate the report 141 and determine a ranking (e.g., from one to ten) for the user based on the content of the report 141. In one implementation, system 100 can first determine whether one or more conditions for the report 141 has been satisfied (e.g., whether a certain number of responses have been provided, whether images have been provided for particular instructions, and/or whether required or necessary information has been provided). If the one or more conditions are not satisfied, the user can be prompted to provide additional information for the inspection and/or start over from the beginning. On the other hand, if the one or more conditions have been satisfied, system 100 can rank or rate the user.

The user can be ranked or rated based on (i) the completeness of the report 141, (ii) the accuracy of the responses as compared to the instructions, and/or (iii) the overall quality of the provided responses. System 100 can also compare the report 141 to a model or exemplary report to determine deficiencies to the report 141 and to notify the user of the deficiencies before the report is transmitted to other services or linked to an online listing.

Still further, as an addition or an alternative, system 100 can be specifically designated for a particular type of asset. For example, system 100 can be implemented through software that operates on a mobile computing device, such as an application that runs on the mobile computing device. The application can be suited for only real estate property inspections, for example, instead of other types of assets. In such cases, the instruction generate 110 does not determine the type of assets based on input received from a user, but can, by default, determine the type of asset as being a real estate property. Nonetheless, the instruction generate 110 can determine one or more characteristics of the asset from received inputs.

Although system 100 has been described as being implemented on a user's computing device (e.g., as part of an asset inspection application), in other examples or implementations, one or more components of system 100 can be implemented remotely from the user's computing device. According to one example, one or more components, such as the report generate 140, can be implemented on remote computing devices or servers that can communicate, over a network(s), with the user's computing device. In other examples, the instructions 111 can be provided as part of a web page that is presented on a browser application.

### Methodology

FIG. 2 illustrates an example method for providing instructions for conducting an inspection of an asset. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

In FIG. 2, a user is prompted to enter a variety of inputs, where the inputs are indicative of a type of asset that is being inspected (210). The prompt enables the user to provide an input indicating the type of asset so that instructions for conducting an inspection can be based on the determined type. Types of assets can include, but are not limited to, a new product, a collectible item (e.g., paintings, trading cards), an antique item, a vehicle, or a real estate property. In some examples, the user can be prompted for the asset type once the user launches or starts an asset inspection application on the computing device, or once the user begins a new asset inspection process using the computing device to generate a report.

The user can also provide input that is indicative of one or more characteristics of the asset (220). A characteristic of the asset can include a brand, a style, a location, the age of the asset, etc. For example, for a real estate property, the characteristics can include the type of real estate property (e.g., a house, a condo, an apartment, a business property, land, etc.), the location the property is located in, and/or the age of the real estate property.

Based on the type of asset and/or one or more characteristics of the asset, instructions can be provided for the user to follow in performing the inspection (230). These instructions can be tailored to be specific to the type of asset and/or one or more characteristics of the asset that is being inspected. For example, one or more instructions can be selected or configured based on certain characteristics of the asset (e.g., different instructions can be provided for a residential home inspection versus a commercial real estate inspection, or based on the location of the real estate property). The instructions can include prompts for the user to provide responses to and/or captures images or videos specifying certain aspects of the asset. In one example, the instructions can be provided in sequence from start to finish. The user can be instructed by a guide that provides a walkthrough for conducting the inspection from start to finish, so that the user can complete (or respond to) an instruction before moving on to the step or phase of the inspection process. In some cases, the user can skip through phases and return to phases, save or revisit the instructions at a later time, etc.

An instruction can be provided, at least in part, by a user interface that is displayed on the computing device of the user. The user can respond to the prompt by providing user input corresponding to the particular instruction (240). The instruction can request text, audio, images, video, etc., to be provided by the user. For example, the instructional user interface can also provide a text field or text box for the user to input a description or detail about a particular aspect of the asset inspection. In other examples, the user interface can provide a multiple choice answer set or set of rankings (e.g., A—Excellent, B—Great, C—Satisfactory, D—Poor, E—Terrible) that the user can select for the particular instruction/question (e.g. “provide a rating for the condition of the basement.”) and a prompt asking the user to upload images representing the selected ranking.

If there are one or more additional instructions 250 for conducting the inspection of the asset, the one or more additional instructions 250 are provided to the user (return to 230 and then 240). However, if there are no more instructions (e.g., the user has responded to all of the instructions provided) for conducting the inspection, the report can be generated (260) based on the user inputs corresponding to each of the instructions (250). For example, the report generate 140 of FIG. 1 can use a report template that is specific to the determined asset type and fill in the appropriate fields/sections of the report template with the responses provided by the user (e.g., based on the associated user input and instructions).

Once the report is generated, it can be provided to other services or sources (270). In one example, the report can be linked to an online listing for transaction for the asset. Users can access the online listing in order to view the report (as well as information corresponding to the report, when the report was created, the user who created the report, the user's rating, etc.). In some cases, users can also view, when accessing the online listing, images or videos provided as part of the report to verity the asset and the condition of the asset as described in the report.

### User Interface Examples

FIGS. 3A through 3E illustrate example user interfaces providing instructions for conducting an inspection of an asset. The user interfaces of FIGS. 3A through 3E illustrate various user interfaces that can be provided by an asset inspection application running or being operated on a computing device of a user (e.g., a mobile computing device). The user interfaces of FIGS. 3A through 3E provide instructions that are specific to a type of asset and/or characteristic(s) of the asset that the user of the computing device is inspecting for purposes of transaction, as described with FIGS. 1 and 2.

FIG. 3A illustrates a user interface 300 that provides a prompt requesting a user to select a type of asset that the user would like to inspect. In one example, the user interface 300 includes a selection feature 302 in which the user can input the type of asset to be inspected. Depending on implementation, the user can manually input characters in the selection feature 302, or select a drop-down feature that, when selected, displays a menu 304 showing one or more options 306. The options 306 can correspond to a collectible item, an antique item, a vehicle, a real estate property, etc. Once the user makes a selection, the user can select the “continue” feature 308 to continue with the inspection process.

FIG. 3B illustrates a user interface 310 that displays a prompt requesting the user to provide additional information about the selected asset, such as one or more characteristics of the selected asset. In the example of FIG. 3B, the user has selected real property as the type of asset (e.g., on the user interface 300 of FIG. 3A). In another example, the asset inspection application can correspond specifically to a real property inspection tool. In such an example, the user interface 310 of FIG. 3B can presented to the user as part of the asset inspection application without requesting the user to select a type of asset.

The user interface 310 can provide multiple interactive features, with each feature corresponding to a characteristic of the asset being inspected. For example, the user interface 310 presents a feature 312 for selecting a type of real property being inspected (e.g., a single family house, a condominium, an apartment, a commercial building, land, etc.). The user can select a drop-down feature that, when selected, displays selection options or a menu showing different options for the type of real property. The user interface 310 can also present a geographic location feature 314 for inputting a location of the real property. The user can input an address or zip code or city, etc., in the feature 314. The user interface 310 can also request the user to provide a type of transaction for the real property by interacting with the feature 316 (e.g., a consumer-to-consumer transaction, a short sale, a foreclosure). In other examples, the user interface 310 can include other features for providing other characteristics of real property, such as the year the real property was built, square footage, etc. The user can select the “continue” feature once the user provides the information or select the “back” feature to go back to the previous user interface 300 and select a different asset type.

The asset inspection application can guide the user to inspect appropriate features of an asset while providing a mechanism to enable the user to provide important information about the inspections. For example, for a real property, user interfaces can be displayed to guide the user to inspect various aspects of the real property (e.g., a single family house). The user interface can provide instructions that guide the user to inspect the roof, the basement, the attic, the air conditioning or heating system, the plumbing, the electrical system, the water heater, the fire alarm system, the sprinkler system, the appliances, etc.

FIG. 3C illustrates a user interface 320 that displays instructions prompting the user to inspect or check a certain aspect of the asset. In the example of FIG. 3C, the user interface 320 provides instructions 322 for inspecting the foundation of the real property (e.g., “Check the exterior of the house: Are there cracks on the walls? Are there shifts in foundation?”). The user interface 320 also provides an input field 324, in which the user can input information regarding the foundation inspection. The user interface 320 can also provide a selectable feature 326 corresponding to a camera that, when selected, enables the user to take photo(s) and/or video(s) for purposes of documenting or recording information pertaining to the aspect of the asset being inspected. When the user has finished providing information related to the instructions 322, the user can select the “continue” feature to continue with the asset inspection. The asset inspection application can then display another user interface and/or other instructions prompting the user to inspect other parts of the asset with respect to the foundation inspection or to inspect another aspect of the asset when the foundation inspection is completed (e.g., the roof, the electrical system, etc.).

FIG. 3D illustrates another user interface 330 that displays instructions prompting the user to inspect an aspect of the asset. The user interface 330 is similar to the user interface 320 of FIG. 3C, except that the user is provided pre-configured options/answers for certain instructions. For example, the user can be instructed to inspect the foundation of the real property (e.g., “Are there cracks on the walls?”), and provide an answer by selecting one of the selectable features 332 (e.g., corresponding to yes or no). Each specific instruction can also include a selectable feature 334 corresponding to a camera that, when selected, enables the user to take photo(s) and/or video(s) pertaining to the specific instruction. In this manner, when the user selects the feature 334 with respect to the instruction “Are there cracks on the walls?” and takes a photograph of a wall with a crack, that photograph can be associated with that particular instruction. The user interface 330 can also provide input fields 336, in which the user can input information regarding individual instructions, respectively.

In some examples, the user is prompted to take a photograph when it is necessary to do so. Depending on implementation, in FIG. 3C or 3D, the selectable features 326, 334, respectively, may not be displayed for certain instructions, in which photographs are not needed (e.g., the instruction asking the user “Is there any odor present?” or “Can you hear vehicles along the main road?”). In one example, the asset inspection application can display the selectable features 326, 334 when the user provides a response (via input) in which a photograph(s)/video(s) is helpful and/or necessary (e.g., when the user says that there is a problem with an aspect of the asset). For example, when the user selects “Yes” as a response to “Are there cracks on the walls?,” the selectable feature 334 can then be dynamically displayed on the user interface 330 of FIG. 3D in response to the user selection. In another example, the camera of the computing device can be activated or initiated in response to the user selecting “Yes” as a response, and the asset inspection application can display/provide the image or video capturing user interface on the display of the device.

FIG. 3E illustrates another user interface 340 that displays instructions prompting the user to inspect another aspect of the asset. The user interface 340 can be displayed, for example, after the user completed inspection of another aspect of the asset (e.g., after the user completed the foundation inspection). Depending on implementation, different aspects of inspections can be provided to the user and can be ordered differently based on the type and/or characteristic(s) of the asset. For example, for an apartment in a high rise, instructions pertaining to a sprinkler system will not be displayed to the user, while instructions pertaining to the lobby or elevator can be provided. In another example, instructions can be ordered to be tailored for the user's convenience and ease based on the type and/or characteristic(s) of the asset (e.g., inspect the outside of the real property before inspecting the inside).

Referring back to FIG. 3E, the user interface 340 can provide instructions for an aspect of the asset (e.g., roof inspection). The instructions can be provided with pre-configured responses for the user to select. For example, the user interface 340 can provide a multiple choice answer set or set of rankings 342 (e.g., 1 through 10) that the user can select for a particular question (e.g., “What is the overall condition?”). Again, the user can select the camera feature 344 to take a photo, if necessary. In other examples, when the user selects a ranking that is less than a predefined ranking (e.g., less than 7), the user can be prompted (e.g., a pop-up prompt that overlays the user interface 340) to take a photo of the aspect of the asset being inspected (e.g., take a photo of the roof).

In this manner, the user interfaces of FIGS. 3A through 3E can guide the user to properly inspect an asset in order to be thorough and/or to comply with business or governmental requirements. For a real estate inspection, for example, a user can operate a mobile computing device that runs the asset inspection application, walk around and inspect the property by following the directions that are tailored for that asset, and take photos and/or videos when necessary. When the user has completed the inspection, the asset inspection application can automatically generate a report corresponding to the inspection and/or upload the report to the user's account and/or one or more services.

### Hardware Diagram

FIG. 4 is a block diagram that illustrates a computing device upon which examples described herein may be implemented. In one example, a computing device 400 may correspond to a mobile computing device, such as a cellular device that is capable of telephony, messaging, and data services. Examples of such devices include smartphones, handsets or tablet devices for cellular carriers. Computing device 400 includes a processor 410, memory resources 420, a display device 430 (e.g., such as a touch-sensitive display device), one or more communication sub-systems 440 (including wireless communication sub-systems), input mechanisms 450 (e.g., an input mechanism can include or be part of the touch-sensitive display device), and a camera component 460. In one example, at least one of the communication sub-systems 440 sends and receives cellular data over data channels and voice channels.

The processor 410 is configured with software and/or other logic to perform one or more processes, steps and other functions described with implementations, such as described by FIGS. 1 through 3E, and elsewhere in the application. Processor 410 is configured, with instructions and data stored in the memory resources 420, to operate, for example, an inspection application as described in FIGS. 1 through 3E. For example, computer-executable instructions for operating the inspection application to display various user interfaces, such as described in FIGS. 1 through 3E, can be stored in the memory resources 420 of the computing device 400. In one implementation, a user can operate the inspection application to conduct an inspection of an asset. The user can provide one or more inputs 455 via the input mechanisms 450 so that the inspection application provides instructions 415 that are specific to the type of asset that is being inspected. In some implementations, the user can interact with a touch-sensitive display 430 to make selections that are provided with one or more user interfaces and/or instructions 415 (e.g., such as illustrated in FIGS. 3A through 3E).

In some examples, the user can operate (e.g., through use of the inspection application) the camera component 460 to provide image data 465 that is to be included in the report for the inspection of the asset. For example, one or more of the instructions 415 that are presented to the user can instruct the user to take an image related to the asset being inspected. The camera component 460 can provide image data 465 that corresponds to a scene that the user wishes to capture an image of. Based on the user inputs corresponding to each of the instructions 415, the inspection application can generate a report 445. The generated report 445 can be provided to the communication sub-systems 440 to be transmitted or linked to other services. The communication sub-systems 440 can enable the computing device 400 to communicate with other servers and computing devices, for example, over a network (e.g., wirelessly or using a wireline). The report 445 can be communicated to other services that can use the report as part of an online listing for transaction for the asset. While FIG. 4 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A computer-implemented method for conducting an inspection of an asset, the method being implemented by one or more processors and comprising:
prompting a user to enter one or more inputs, including an input that is indicative of a type of asset that is being inspected;
based, at least in part, on the determined type of asset, providing instructions that are specific to the determined type of asset for the user to follow in performing the inspection;
receiving user input corresponding to each of the instructions; and
generating a report based on the received user inputs.

2. The method of claim 1, further comprising linking the report to an online listing for transaction for the asset.

3. The method of claim 1, further comprising determining information about one or more characteristics of the asset, and wherein providing instructions includes selecting or configuring the instructions based on the one or more characteristics.

4. The method of claim 3, wherein the asset corresponds to a real property asset, and wherein the one or more characteristics identify a type of real property asset or a geographic location of the real property asset.

5. The method of claim 3, wherein the asset corresponds to a real property asset, and wherein the one or more characteristics identify a type of transaction for the real property asset.

6. The method of claim 5, wherein the type of transaction corresponds to one of a consumer-to-consumer transaction, a short sale, or a foreclosure.

7. The method of claim 1, wherein providing instructions includes outputting audio instructions, and wherein receiving user input includes receiving audio input via a microphone of the computing device.

8. The method of claim 1, wherein providing instructions includes presenting, on a display of a computing device, a plurality of user interfaces, each of the user interfaces including at least one of text, images, or videos, and wherein receiving user input includes receiving at least one of (i) audio input via a microphone of the computing device, or (ii) input provided via one or more input mechanisms of the computing device.

9. The method of claim 8, wherein one or more of the plurality of user interfaces can provide a prompt instructing the user to capture an image using a camera component of the computing device.

10. The method of claim 1, wherein generating the report includes (i) determining a report template corresponding to the determined type of asset, and (ii) including, in the determined report template, content that is based on the received user inputs.

11. A mobile computing device comprising:
one or more memory resources;
one or more input mechanisms;
one or more processors coupled to the one or more memory resources and the one or more input mechanisms, the one or more processors to:
prompt a user to enter one or more inputs, including an input that is indicative of a type of asset that is being inspected;
based, at least in part, on the determined type of asset, provide instructions that are specific to the determined type of asset for the user to follow in performing the inspection;
receive user input corresponding to each of the instructions; and
generate a report based on the received user inputs.

12. The mobile computing device of claim 11, wherein the one or more processors links the report to an online listing.

13. The mobile computing device of claim 11, wherein the one or more processors determine information about one or more characteristics of the asset, and wherein the one or more processors provide instructions by selecting or configuring the instructions based on the one or more characteristics.

14. The mobile computing device of claim 13, wherein the asset corresponds to a real property asset, and wherein the one or more characteristics identify a type of real property asset or a geographic location of the real property asset.

15. The mobile computing device of claim 13, wherein the asset corresponds to a real property asset, and wherein the one or more characteristics identify a type of transaction for the real property asset, the type of transaction corresponding to one of a consumer-to-consumer transaction, a short sale, or a foreclosure.

16. The mobile computing device of claim 11, further comprising:
a speaker;
a microphone;
wherein the one or more processors provide instructions by outputting audio instructions via the speaker, and wherein the one or more processors receives user input by receiving audio input via the microphone.

17. The mobile computing device of claim 11, further comprising:
a display;
a microphone;
wherein the one or more processors provide instructions by presenting, on the display, a plurality of user interfaces, each of the user interfaces including at least one of text, images, or videos, and wherein the one or more processors receives user input by receiving at least one of (i) audio input via the microphone, or (ii) input provided via the one or more input mechanisms.

18. The mobile computing device of claim 17, further comprising a camera component, and wherein one or more of the plurality of user interfaces can provide a prompt instructing the user to capture an image using the camera component.

19. The mobile computing device of claim 11, wherein the one or more processors generate the report by (i) determining a report template corresponding to the determined type of asset, and (ii) including, in the determined report template, content that is based on the received user inputs.

20. A non-transitory computer-readable medium storing instructions that, when executed by one or more processors, cause the one or more processors to:
prompt a user to enter one or more inputs, including an input that is indicative of a type of asset that is being inspected;
based, at least in part, on the determined type of asset, provide instructions that are specific to the determined type of asset for the user to follow in performing the inspection;
receive user input corresponding to each of the instructions; and
generate a report based on the received user inputs.
